(19) United States
(12) Patent Application Publication
(10) Pub. No.: US 2010/0181714 A1
(43) Pub. Date: Jul. 22, 2010

(54) Vice Jaw System for Clamping Machinable Work-pieces

(76) Inventors: Larry R. Calhoun, Gresham, OR (US); Shawn R. McCrary, Portland, OR (US)

Correspondence Address: PETER A. HAAS, ESQUIRE, 1929 SW 13TH AVENUE, PORTLAND, OR, 97201, US

(21) Appl. No.: 12/356,850

(22) Filed: Jan. 21, 2009

(51) Int. Cl. B25B 1/24; B23P 19/04

(52) U.S. Cl. 269/283; 29/700

(57) ABSTRACT

A gripping element comprises a generally cylindrical grip body having a top and a center hole disposed on the grip body and arranged to pass generally through a centerline of the body and being disposed generally perpendicular to and extending downwards from the top. The grip body further includes two gripping edges, each located opposite the other arranged on the top. Each gripping edge, in turn, adapts to penetrate a linear portion of the work-piece without requiring a preparation operation on the work-piece. Each gripping edge comprises a pair of teeth. Each tooth being defined by the second a top edge and an oppositely disposed fin tapering from the top edge toward the grip body, the fin intersecting with an outward taper feature and the taper feature terminating on a shoulder disposed on the grip body.

### BACKGROUND

This present invention relates generally to vise jaw inserts and more particularly to insertable work-piece holders used to precisely position and reliably secure work-pieces during machining operations.

Before becoming a finished part, a work-piece may undergo many varied mechanical operations by various machine tools. Each tool and each operation requires a precise orientation of the work-piece to ensure that each work-piece conforms to design tolerances and functional intent. Thus, it is vital that the work-piece be positioned precisely and secured, yet also remain releasable from the holder when the operation or series of operations is complete. However, for a given tool feed and speed using traditional clamping devices and methods, there is a direct correlation between the amount of force required to hold a work-piece and the efficiency (speed) of the machining operation. With the ever-increasing need to improve throughput and efficiency, there is a corresponding need to better secure work-pieces.

Further, modern machine tools are capable of performing multiple operations on a single work-piece and can include horizontal, vertical, or angular operations on a single work-piece. Traditional clamping work-piece holding solutions are often inadequate for this task. Thus, an improved work-piece holder should enable a single machine to perform multiple operations without requiring a refixturing of the work-piece relative to the tool.

In the prior art, widely used and well-known methods and devices for securing a work-piece for machining operations have limitations on the tool speed and feed and/or limitations on the orientation of the tool relative to the work-piece. Such traditional systems typically consist of a clamping device with jaws of hardened steel or jaws of non-hardened material that are machine cut or otherwise shaped to match contours of the work-piece. Often the work-piece does not have a suitable surface, so an added process is required to prepare the work-piece. This added step adds cost and reduces efficiency. Once prepared, the work-piece is placed between the jaws and supported vertically by using some form of support device to set the work-piece at the desired height, or by the work-piece resting directly on the machined support surface of the shaped jaws. The clamping device is actuated causing the jaws to contact the work-piece with pressure to secure the work-piece between the jaws while machining operations are performed.

And, as work-pieces become more and more irregularly shaped and utilize less and less material, the problem of securely and precisely holding the work-piece with traditional systems becomes increasingly difficult, if not impossible, to solve, resulting in additional complexity, cost and inefficiency.

Representative known devices for gripping work-pieces include a vise system consisting of a master jaw, hard jaw, and soft jaw of Bowling disclosed in U.S. Pat. No. 4,251,066 issued on 17 Feb. 1981. According to Bowling, a work-piece is held between soft jaws, which slideably fit to the master jaw by a cooperating and mating dovetail groove. The work-piece is held between oppositely positioned and a cooperating pair of soft jaws. Each soft jaw includes a machined recess for tightly engaging the corresponding side of the work-piece. See, for example, FIG. 6 of Bowling. As such, the Bowling device uses friction and pressure to hold the work-piece in relative position between the jaws and, accordingly, requires a relatively flat surface on the work-piece and the flat surface on the work-piece must be aligned with the flat surface of the jaw for the vise to hold. As the contact area between the jaw and work-piece diminish, additional clamping force (pressure) must be applied for a given tool speed. Alternatively, tool speeds must be reduced to reflect the loss of clamping force.

Another traditional device, disclosed in U.S. Pat. No. 4,602,772 issued on 29 Jul. 1986 Wight et al., teaches a substantially flat, vertical clamping wall (item 62 in FIG. 1 of Wight, for example). Improvements to the flat clamping wall include work-piece matching profiles. For example, a representative clamping system for work-pieces includes a vise jaw support system and interchangeable vise jaws taught by Dossey et al. in U.S. Pat. No. 4,706,949 issued on 17 Nov. 1987. As FIG. 5 (of Dossey) illustrates, a clamping system includes a collection of interchangeable vise inserts to better enable clamping of the vise to the work-piece. Specifically, Dossey discloses that each of the interchangeable vise jaws has a flat, vertical work-piece-engaging surface opposite to the attaching end surface of the vise jaw and another work-piece-engaging engaging surface is provided with a plurality of V-shaped slots that intersect one another (item 70 in FIG. 5 of Dossey, for example) of varying depths to accommodate different sized rounded and hexagonal shaped work-pieces. However, as problematic in the aforementioned Bowling device, the Dossey system also requires friction and pressure to hold the work-pieces relative to the tool position.

Yet another known clamping system for work-pieces teaches clamping force pressure and surface area in contact with the work-piece: For example, a rounded vertical wall jaw as taught by Engibarov in U.S. Pat. No. 5,060,920 issued 29 Oct. 1991. As FIGS. 1 and 3 (of Engibarov) illustrate, a block 22 includes a curvilinear sidewall feature 29, which is adapted to engage a cylindrical work-piece 12. This design has the same limitations previously discussed and relies solely on the clamping force exerted by the frictional contact area between the jaw and work-piece.

Disadvantages common with the aforementioned representative teachings include requiring specific clamp inserts that have a universal vise-engaging side and an oppositely disposed work-piece engaging side wherein the work-piece-engaging side includes a vertical sidewall having a contour that either is flat or follows the contours of a feature on the work-piece. Thus, for each new work-piece, a corresponding new vise insert is required. This requires an extensive and ever-expanding inventory of work-piece holders that are unique to the machining operation and individual work-piece. It will be well-appreciated by those familiar with this art that managing, storing, creating, and maintaining such a diverse assortment of holding pieces requires considerable capital and human resource expenditure. Moreover, such clamping force areas inherent in these aforementioned prior-art designs have practical limitations on the feed and speed of the machining operation—too much speed or to high of feed rates will over come the effective clamping force and cause the parts to dislocate from the machining vise fixture. This results in waste in the form of damaged or scrapped work-pieces or as reduced efficiencies in the machining process. Thus it would be desirable to have a more universal holding piece that can be used for varying sized and shaped work-pieces and for various machining operations.

One attempt to provide a more universal work-piece holder includes the device disclosed by Carossino in U.S. Pat. No. 4,915,367 issued on 10 Apr. 1990. Therein, in one embodiment (FIG. 6 of Carossino), a rectilinear clamping apparatus and, in another embodiment (FIG. 10 of Carossino), a curvilinear clamping apparatus includes features that enable the clamp to be securely and releasably mounted to a vise jaw and work-piece engaging cramps. Carossino's cramp pieces include three fingers extending on one of its longitudinal sides, two of the fingers being elastically deformable with the third finger being relatively rigid to form a deflection-limiting abutment against the work-piece. The clamping member uses the same principle of providing pressure and a relatively large contact area against the work-piece via a relatively flat, vertical wall resting against a vertical feature on the work-piece.

Unfortunately, using standard hard jaws with parallels and soft jaws as just described by representative known devices are ineffective in many cases.

For example, in machining operations where the tool exerts a force transverse to the clamping force, the work-piece shifts or alters its position relative to the tool. Work-piece shift also occurs when the work-piece extends substantially above the horizontal plane of the vise jaws and the tool travels in a direction parallel to the clamping force. Rotational torque of the tool also can cause the work-piece to shift in traditional holders. And, as tool heads rotate with increasing speeds to improve operational efficiency, these problematic tendencies increase.

Recognizing the inherent limitations of traditional work-piece holders, Klabo describes in U.S. Pat. App. Publication No. US2002/0056955, published on 16 May 2002, a vise jaw utilizing a series of gripping pads located laterally along the jaw. Thus, when tightened by the vise, the jaw introduces a horizontal force on the work-piece causing the gripping pads to penetrate and gouge the work-piece, which thereby increases the retention capabilities, which enables a greater range of work-pieces shapes to be held over the previously discussed references. The Klabo device includes a vise jaw having an L-shaped body having a flat, milled surface that runs the length of the body and (oppositely positioned) a plurality of gripping pads disposed laterally along the length of the vise jaw. Each gripping pad protrudes horizontally and is perpendicular to the contact surface. A cross-section of the gripping pad is characterized by a relief cut on the bottom of the gripping pad and a chamfered surface at the top of the gripping pad. The penetrating gripping pad of Klabo improves the traditional, known contact pads. However, the Klabo gripping pad requires a significant amount of vertical wall on the work-piece to penetrate effectively. Moreover, the Klabo gripping pad works in cooperation with a plurality of pads and, thus, the more horizontally linear the work-piece's vertical wall the more effective the gripping force exerted. As work-piece vertical walls become more horizontally curvilinear, the less gripping force available by the Klabo device.

Thus, there remains a need for a system including a work-piece holding device that adapts for use to clamp different sized and shaped work-pieces that improves the pressure/frictional claming area design common in the prior art. Moreover, such a work-piece holding device should be universal to accommodate a large number of varying sized and shaped work-pieces to reduce the number and complexity of vise inserts required to hold a variety of work-pieces in a variety of orientations for a variety of machining operations on a variety of machine tools. Further, an improved work-piece holder should overcome the limitations of the relatively flat vertical-wall clamping surface that relies on surface area to pressure-hold a work-piece relative to a vise jaw and machine tool. An improved work-piece holding device, additionally, should penetrate the work-piece, but minimize the required work-piece vertical wall and adapt for use for curvilinear or linear (in the horizontal) vertical walls on the work-piece.

### SUMMARY OF THE INVENTION

In contrast to the present invention, traditional work-piece holding is accomplished using a clamping device with jaws of hardened steel or jaws of non hardened material that are machine cut or shaped to match the work-piece. The work-piece material is placed between the jaws and supported vertically by using some form of support device to set the work-piece at the desired height, or by the work-piece resting directly on the machined support surface of the shaped jaws. The clamping device is actuated causing the jaws to contact the work-piece with pressure to secure the work-piece between the jaws while machining operations are performed.

This prior art method of work holding requires that the surfaces of the work-piece being clamped on are in such condition so that the contact area of the jaws on the material, have enough frictional resistance to prevent unintended movement of the work-piece while machining operations are performed. Unintended movement of the work-piece during machining will normally cause the machining operation to be unsuccessful wasting the material and causing damage to the cutting tool and/or the machine used for the operation. Work-piece movement can also be dangerous to personnel if the work-piece is dislodged during a machining operation and is ejected from the machine at high velocity.

The present invention overcomes limitations of the prior art and provides improved methods and devices for holding a work-piece in a vise, a lathe chuck, or special fixtures to clamp a work-piece while machining operations are performed.

In one preferred embodiment, the present invention consists of a hardened gripping element with two shaped edges or teeth formed into the sides of the grip. The teeth penetrate into a minimal amount of the work-piece material, securing it against movement. Thus, only a thin layer of the work-piece material is engaged by the grip teeth, but it is sufficient to secure the work-piece from movement during machining without prior preparation of the work-piece.

The thin layer of material may be subsequently removed when that surface of the part is machined in later operations. This method of work holding is sometimes referred to as carrier work holding. The amount of work-piece material used for the carrier and then later removed is significantly less than the amount used to clamp on with traditional work-piece clamping devices, thereby reducing cost.

The increased work holding power obtained by the gripping edge teeth penetrating into the work-piece material allow faster metal removal rates and increased safety.

In one preferred embodiment, the hardened gripping element includes a grip body having a cylindrical shape with a counter-bored hole in the center for fastening the grip to a work-piece support substrate using an industry standard cap screw. The grip is placed in a cylindrical pocket in the work-piece support substrate and secured using the cap screw through the grip into a threaded hole in the center of the pocket.

The grip teeth are positioned above the work-piece support surface to engage the desired amount of the work-piece material. The amount of work-piece material engaged is determined by the projection of the grip teeth above the work-piece support surface. A very important feature of the grip is the cylindrical body as it allows the grip to be rotated in the pocket, positioning the teeth to conform to any irregular work-piece material shape. This allows a wide range of work-piece material shapes to be clamped without pre-preparation of the surfaces being clamped.

The work-piece support substrate can be vise jaws, lathe chuck jaws, or other types of work holding fixtures that use any type of clamping device to push the work-piece material against the grips, securing it against movement. This invention further contemplates a method of work-piece holding using a vise, a lathe chuck or special fixtures of various embodiments further described herein to clamp a work-piece while machining operations are performed. These methods have wide use and varied applications for securing a work-piece for machining operations.

### DRAWING

FIG. 1 is an off-set top view of a work-piece holder according to a first preferred embodiment of the present invention.

FIG. 2 is a front view of the holder of FIG. 1.

FIG. 3 is a top view of the holder of FIG. 1.

FIG. 4 is a side view of the holder of FIG. 1.

FIG. 5 is an exploded view of a holder and substrate according to a second preferred embodiment of the present invention.

FIG. 6 is an off-set top view of the holder and substrate of FIG. 5.

FIG. 7 is an off-set top view of the substrate of FIG. 5.

FIG. 8 is an off-set top view of another substrate according to another preferred embodiment of the present invention.

FIG. 9 is an exploded view of an alternative embodiment of the present invention.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

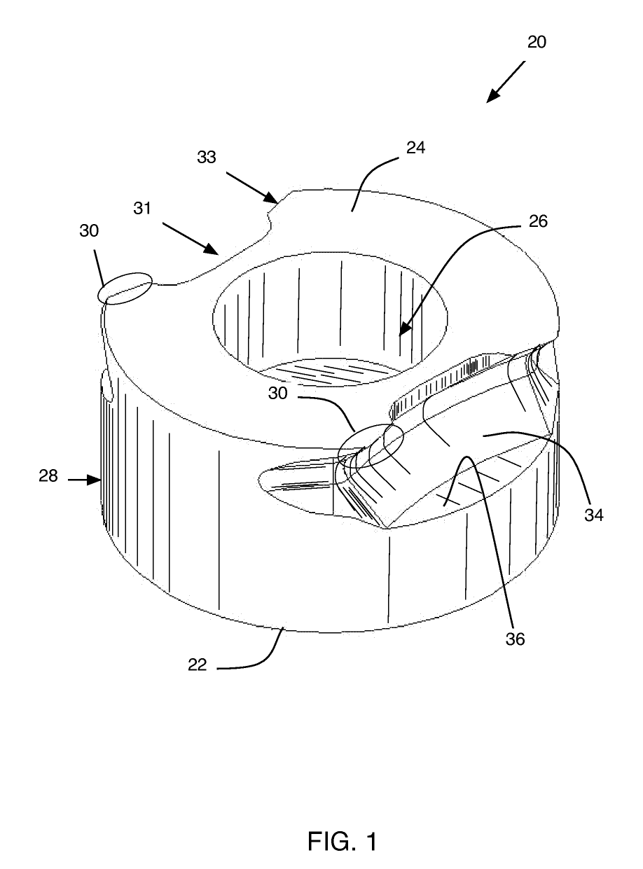

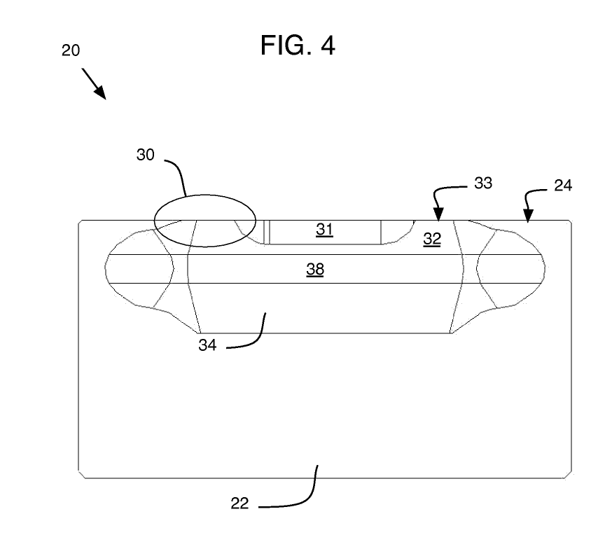

FIGS. 1-4 illustrate a gripping element 20 according to a preferred embodiment of the present invention. The gripping element consists of a generally cylindrical grip body 22 having a generally flat circular top 24 and a hollow center defined by a tapered through hole 26 disposed generally at the center of the body and extending downward from and generally perpendicular to the top surface 24. The center hole enables a fastener to pass partially through so that the fastener head is flush with the top 24 of the gripping element (as further discussed below). The top further includes at least one, and preferably two, oppositely positioned gripping edges, each gripping edge adapted to penetrate a linear portion of a work-piece when the gripping element is properly positioned and secured in a vise, chuck, or lathe jaw (discussed further, below).

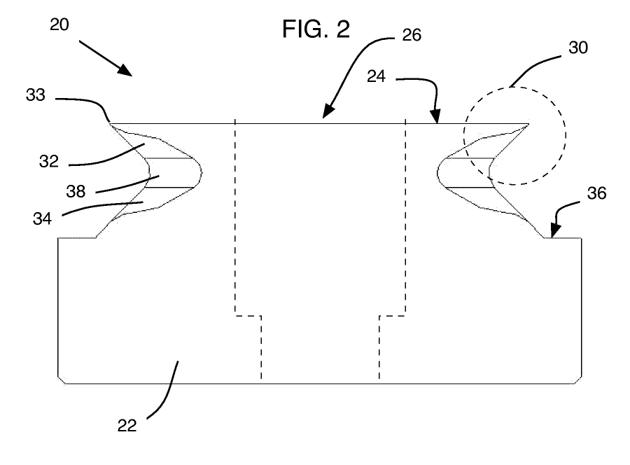

The gripping edge 33 consists of at least one tooth, but preferably a pair of teeth 30, which are separated from each other by a curvilinear recess 31. Each tooth 30 has a top-portion defined by the grip body's top 24. This gripping edge 33, when viewed from the front of the body 22 appears as a point, and when viewed from the side appears as a line. This sharp gripping edge 33 has an undercut and supporting fin 32 that dramatically tapers from the outer edge of the top of the grip body and descends toward the centerline of the body as best illustrated in FIG. 2. A channel 38 rounds toward an outward taper 34, which rests on a shoulder 36 arranged on the grip body. Key to the gripping element, the tooth 30 requires a dramatic taper or undercut of the fin 32 to present a very sharp linear edge to a targeted work-piece. The resulting taper 34 and channel 38 and shoulder 36 are based on the manufacturing tool used to form the gripping edge.

In a preferred embodiment, this gripping element is made from a tool steel that can be hardened by heat treatment. The gripping edges of the insert are machined using a computer controlled milling machine and a shaped circular carbide cutter to cut away material leaving the desired shape. After the gripping element is completely machined, then hardened by a heat treatment process determined by the type of tool steel used. The gripping element must be made hard enough to penetrate the work piece material, but not so hard as to be brittle and thereby fracture when subjected to clamping pressure. A number of different heat treat hardening tool steel materials may be successfully used to make the gripping inserts.

Although a single tooth, as previously described, would be adequate, a preferred embodiment includes a gripping edge consisting of a pair of separated but cooperating teeth, wherein the first and second tooth are identical as previously described. Further, to enhance longevity of the gripping element and to facilitate a more easily marketable and efficiently machined product, the gripping element includes a pair of gripping edges, each gripping edge positioned opposite the other on the top of the grip body. As FIG. 1 shows, the two gripping edges are about 180-degrees apart and each gripping edge consumes about 30-degrees of the diameter of the circular top. Thus, in alternatively contemplated embodiments, multiple pairs of teeth and corresponding gripping edges could be disposed about the top of the gripping element: Including, for example, a three-edge design with pairs of teeth (or a single tooth) at 0-, 60-, and 120 degrees around the top, or a four-edge design at 0-, 90-, 180, and 270-degrees about the top, etc.

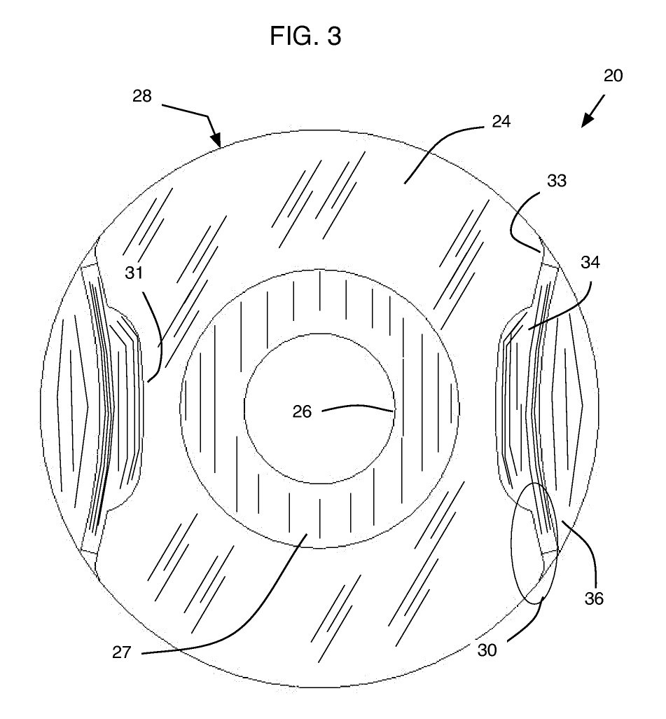

As FIG. 3 illustrates, the center through hole 26 includes a counter-bored shelf 27, the hole 26 defined by a vertical, circular sidewall, and counter-bore 27 being well understood by those skilled in this art, is sized to enable a common threaded fastener to slideably fit its threaded portion through the opening, yet prevent the fastener's head from falling through while simultaneously enabling the fastener to sit flush or below the top surface of the gripping element.

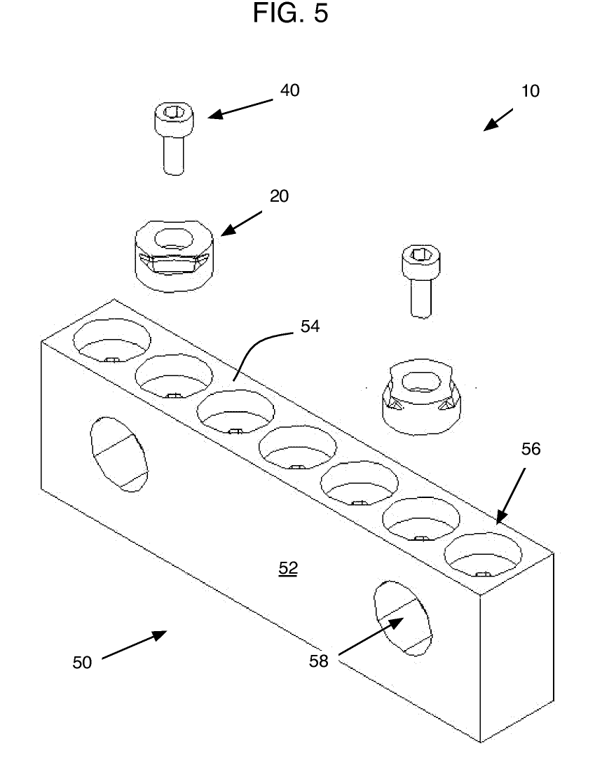

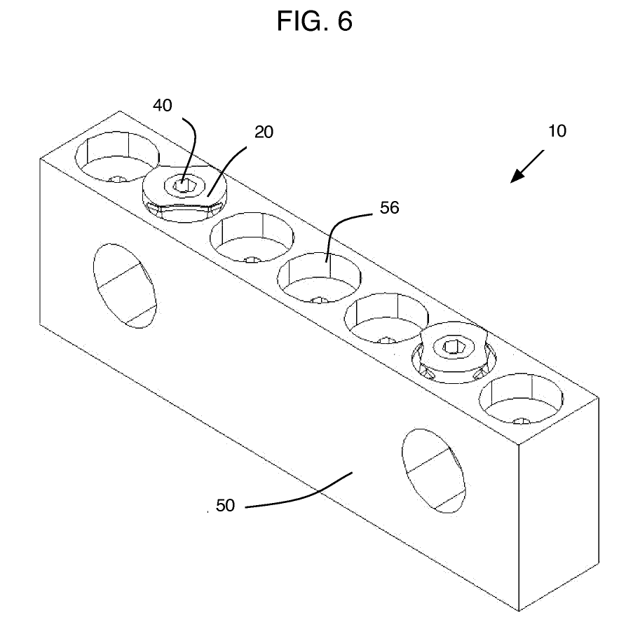

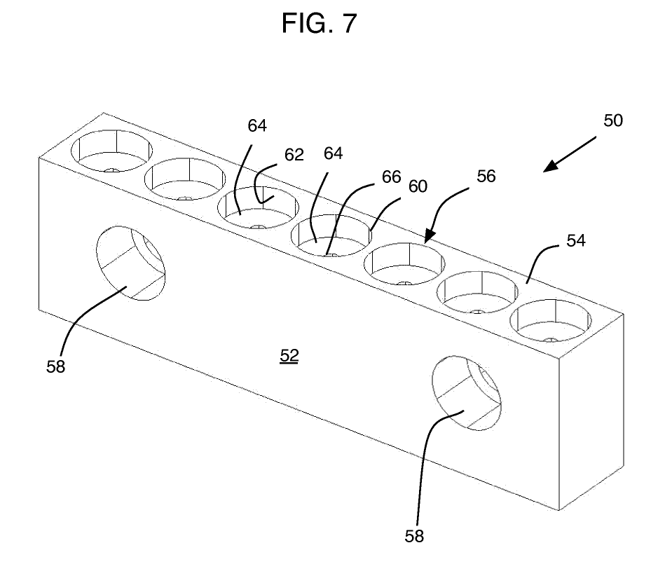

FIGS. 5-7 illustrate a system according to another preferred embodiment of the present invention. The system includes a substrate 50, a means for fastening or coupling 40, and the gripping element 20. In typical work-piece holding operations, a plurality of gripping elements are employed to securely position the work-piece for subsequent machining operations. At least two, more-typically three or more, gripping elements are positioned at desired locations on a work-piece as would be well-understood in this art. However, the system 10 of the present invention eliminates the preparation stage of prior-art work-pieces.

The system 10 includes, for example, a rectilinear substrate 50, which enables standard vise jaws to couple to the block by means well understood in the art. The substrate 50, accordingly, includes a rectilinear block body 52 having a generally flat, rectilinear top surface 54 and at least one generally circular pocket 56 arranged on the top surface.

Each pocket 56 is defined by a sidewall 62 extending generally perpendicular downwards from the top surface 54 to define a generally curvilinear top edge 60 disposed on the top surface. The sidewall intersects with a generally flat bottom surface 64, the bottom surface and sidewall thereby forming a hollow in the top surface of the substrate or block body 52. Further, the pocket 56 includes a threaded hole 66 disposed on the bottom surface and extending downward therefrom. As such, a standard threaded fastener 40, for example a socket head cap screw or socket flat head cap screw. The system 10 further includes at least one, or preferably a plurality of gripping elements 20 as previously described and at least one, or preferably a plurality of substrates 50 as required by the particular work-piece being machined.

Each gripping element is sized to releasably and rotatably fit inside the pocket 56 located on the substrate 50. As such, the gripping element can rotate 360-degrees inside the pocket in a plane coplanar to the top surface of the substrate. This enables the system to securely position and release any shaped work-piece without prepping the work-piece. When properly positioned, as the gripping element is tightened into the pocket by the fastener, the gripping edge 33 of a tooth 30 adjacent to the work-piece penetrates a portion of the work-piece material. The penetration area on the work-piece is a linear area similar to a “bite” mark a person's tooth would imprint on a soft material.

To better facilitate varied types and sizes of work-pieces, the present invention contemplates a system including a substrate having multiple pockets disposed on various surfaces of the substrate. For example, a rectilinear substrate body 52 includes a plurality of linearly aligned pockets 56.

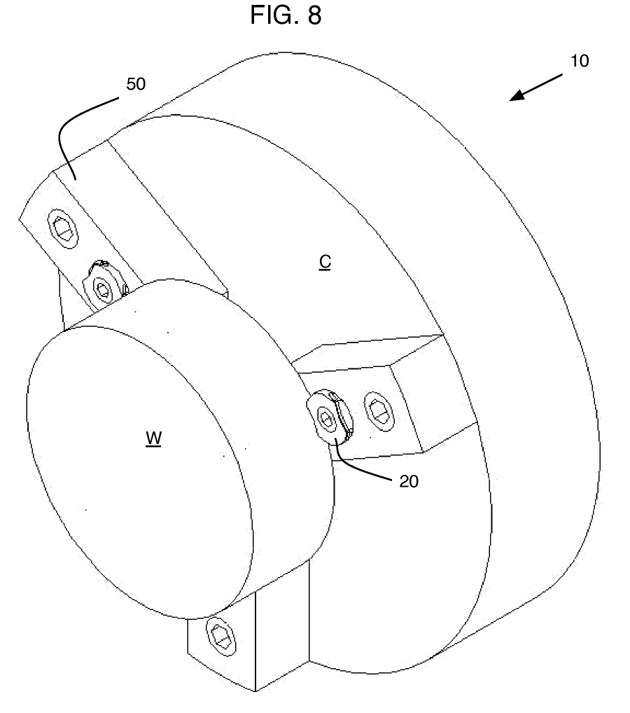

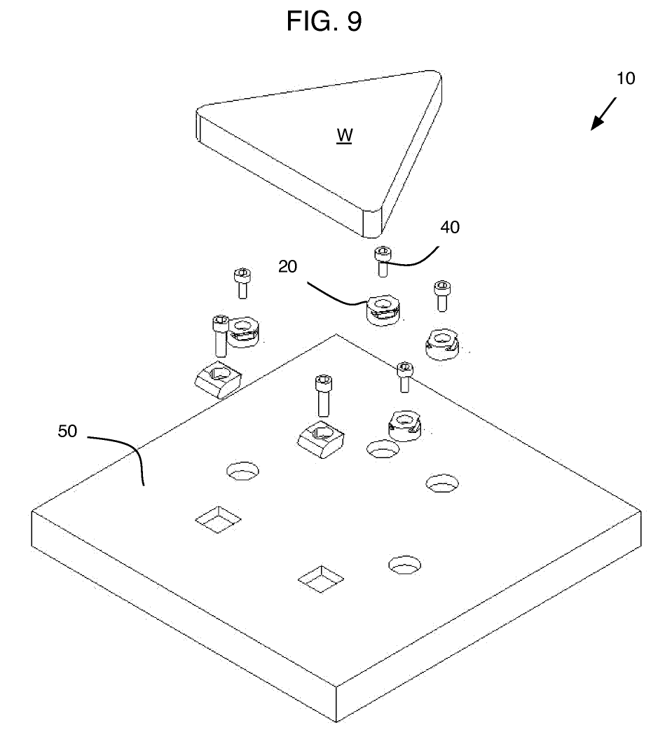

Alternatively, as FIGS. 8 and 9 show, other substrates include lathe chuck jaws, vises or other block mechanisms (designated by the reference “C”) with a plurality of pockets disposed about a surface to better enable the gripping elements to penetrate a surface on a work-piece (designated by the reference “W”).

The substrate 50 further includes means for attaching the substrate to known machine tools including vise jaws, chucks, etc. and, therefore includes mounting holes 58 for attaching to these known structures by known means.

In FIG. 9, a substrate 50 is shown that enables a work piece W to be held using other types of known work piece clamping devices 70 in conjunction with the gripping elements 20. Pockets and threaded holes are machined into the substrate in which the gripping elements 20 and the clamping devices 70 are placed and positioned to locate and secure the work piece W. These types of known clamping devices are used to force the work piece material against the teeth of the gripping element causing the teeth to penetrate the work piece material, locating and securing the work piece for machining operations. This method allows for locating and securing a work piece without the use of a vise or lathe chuck to supply the clamping force that restrains the work piece from lateral movement.

Although the invention has been particularly shown and described with reference to certain embodiments, it will be understood by those skilled in the art that various changes in form and detail may be made without departing from the spirit and scope of the invention.

We claim:

1. A system for holding a work-piece, the system comprising:
a substrate having a top surface and at least one generally circular pocket arranged on the top surface,
the pocket further comprising a sidewall extending generally perpendicular downwards from the top surface to define a generally curvilinear top edge disposed on the top surface, the sidewall intersecting with a bottom surface, the bottom surface and sidewall thereby forming a hollow in the top surface of the substrate and a threaded hole disposed on the bottom surface and extending downward therefrom; and the system further comprising
at least one gripping element comprising
a generally cylindrical grip body having a top and the body being adapted to fit in the pocket of the substrate and wherein the pocket adapts to selectively receive a gripping element,
a center hole disposed on the grip body and adapted to align with the threaded hole of the pocket whereby the threaded hole and center hole cooperate to selectively receive a fastener for selectively coupling the gripping element to the substrate;
the grip-body top further comprising a first gripping edge, the first gripping edge comprising at least a first tooth, the tooth being defined by the gripping edge and an oppositely disposed fin tapering from the gripping edge toward the grip body, the fin intersecting with an outward taper feature and the taper feature terminating on a shoulder disposed on the grip body whereby each tooth presents a sharp bite-edge for linear penetration of the work-piece along the gripping edge of each tooth.

2. The system of claim 1 wherein the first gripping edge further comprises:
a first and second tooth, each tooth being defined by the gripping edge and an oppositely disposed fin tapering from the gripping edge toward the grip body, the fin intersecting with an outward taper feature and the taper feature terminating on a shoulder disposed on the grip body whereby each tooth presents a sharp bite-edge for linear penetration of the work-piece along the gripping edge of each tooth, and wherein the first tooth is separated from the second tooth by a recess feature.

3. The system of claim 1 wherein the gripping element further comprises:
a second gripping edge arranged on the top of the gripping element opposite the first gripping edge.

4. The system of claim 2 wherein the gripping element further comprises:
a second gripping edge comprising a second pair of teeth comprising a third and fourth tooth, each tooth being defined by the second gripping edge and an oppositely disposed fin tapering from the gripping edge toward the grip body, the fin intersecting with an outward taper feature and the taper feature terminating on a shoulder disposed on the grip body whereby each tooth presents a sharp bite-edge for linear penetration of the work-piece along the gripping edge of each tooth.

5. The system of claim 1 wherein the gripping element further comprises:
a counter-bore feature disposed around the center hole and adapted to receive a portion of the fastener.

6. The system of claim 1 wherein the substrate further comprises:
a generally rectilinear block body having a plurality of pockets linearly arranged along the top surface.

7. The system of claim 1 wherein the substrate further comprises:
at least one through-hole arranged on a block body and adapted to enable the substrate to selectively couple to a jaw, chuck, or vise.

8. A gripping element for holding a work-piece, the gripping element comprising:
a generally cylindrical grip body having a top;
a center hole disposed on the grip body and arranged to pass generally through a centerline of the body and being disposed generally perpendicular to and extending downwards from the top;
the grip-body top further comprising a first gripping edge adapted to penetrate a linear portion of the work-piece.

9. The gripping element of claim 8 wherein the first gripping edge further comprises:
a first pair of teeth comprising a first and second tooth, each tooth being defined by the gripping edge and an oppositely disposed fin tapering from the gripping edge toward the grip body, the fin intersecting with an outward taper feature and the taper feature terminating on a shoulder disposed on the grip body.

10. The gripping element of claim 9 further comprising:
a second gripping edge comprising a second pair of teeth, each tooth being defined by the second gripping edge and an oppositely disposed fin tapering from the second gripping edge toward the grip body, the fin intersecting with an outward taper feature and the taper feature terminating on a shoulder disposed on the grip body.

11. A method for holding a work-piece comprising:
providing a plurality of gripping elements, each gripping element having a generally cylindrical body and at least one gripping edge adapted to penetrate a linear portion of the work-piece;
providing a substrates having a corresponding pocket adapted to receive each of the plurality of gripping elements, the substrate enabling the associated gripping element to be selectively coupled to the pocket at any desired orientation about a 360-degree axis in a given plane defined by the substrate;
providing a fastening means for selectively coupling the gripping element in the pocket in the desired orientation;
placing a work-piece between cooperating gripping elements; and
tightening the fastener means causing a respective associated gripping edge to penetrate a linear portion of the work-piece.
